(19) United States
(12) Patent Application Publication
(10) Pub. No.: US 2006/0062338 A1
(43) Pub. Date: Mar. 23, 2006

(54) Method and apparatus for ensuring high quality audio playback in a wireless or wired digital audio communication system

(75) Inventor: Beng Huat Chua, Singapore (SG)

Correspondence Address: STEPHEN B. ACKERMAN, 28 DAVIS AVENUE, POUGHKEEPSIE, NY, 12603, US

(73) Assignee: Freesystems Pte., Ltd.

(21) Appl. No.: 11/227,879

(22) Filed: Sep. 15, 2005

Related U.S. Application Data
(60) Provisional application No. 60/612,007, filed on Sep. 22, 2004.
(60) Provisional application No. 60/612,008, filed on Sep. 22, 2004.

(51) Int. Cl. H04L 7/00

(52) U.S. Cl. 375/372

(57) ABSTRACT

A communication system synchronizes data received and recovered from a transmission medium to the data transmitted such the there is neither under-run nor overrun of the data due to differences in the transmission and reception timing. The data communication system has a transmitter and a receiver. The transmitter encodes digital data into series of symbols and transmits a modulated signal composed of the series of symbols. The receiver acquires the modulated signal, restoring the modulated signal, reconstructing the symbols of the digital data from the modulated signal and synchronizing the digital data to a first reference signal. The digital data is transferred to a buffer data retention circuit. The digital data is transferred from the buffer retention circuit to a jitter management unit. A boundary marker signal detection circuit extracts a marker signal indicating a boundary of symbols of the digital data to provide an indication of the timing of the digital data as broadcasted by the transmitter. A jitter management unit synchronizes the digital data to the first reference signal. The jitter management unit has a FIFO buffer to receive the reconstructed digital data at the rate of the first reference signal from the buffer retention circuit and transmits the synchronized digital data at a rate approximating the timing of the transmitter. The jitter management unit synchronizes the digital data by monitoring the level of the digital data present within the FIFO buffer and adjusting the consumption of the digital data from the FIFO buffer.

### BACKGROUND OF THE INVENTION

This application claims priority to U.S. Provisional Patent Application Ser. No. 60/612,007, filed on Sep. 22, 2004, which is herein incorporated by reference.

### RELATED PATENT APPLICATIONS

“An Apparatus and Method for Adaptive Digital Locking and Soft Evaluation of Data Symbols in a Wireless Digital Communication System,” Provisional U.S. Patent Application Ser. No. 60/612,008, Filing Date Sep. 22, 2004, assigned to the same assignee as this invention.

### FIELD OF THE INVENTION

This invention relates to apparatus and methods for transmission and reception of digital data communication signals. More particularly, this invention relates to the synchronization of received digital data communication signals.

### DESCRIPTION OF RELATED ART

The transmission and reception of digital data is relatively uncomplicated for most wireless or wired applications. However, transmission of digital audio data and playing the audio back reliably at the receiver is more difficult due to the isochronous nature of the audio requirements. A playback system that uses a standard sigma delta audio digital to analog converter has to maintain the audio clocks that demand the audio pulse code modulation samples periodically to sustain a smooth playback. For a wireless transmitter and a receiver that does not perform clock recovery from the transmitted signal, the transmitter's audio clock is different from the receiver's audio clock and thus the rate of production of the digital data versus the consumption of the digital data becomes a problem. The transmitter's clock may be oversupplying the digital data at a faster rate than the receiver can consume the digital or alternately, the transmitter's clock may be undersupplying the digital data at a slower rate and thus starving the receiver of digital data symbols.

An example of a digital data communications system is a wireless infrared digital audio headphone, as shown in FIG. 1. The transmitter 10 acquires digitally encoded audio signals, which are then formatted with synchronization, control, and error signals. The formatted encoded data modulates a transmit signal employing a pulse positioned modulation. The modulated signal is used to control the radiation of a light signal from the light emitting diode (LED) 15. The light signal 20 is broadcast to the headphones 25. The headphones 25 have a photodetector 40. The photodetector 40 are generally placed on the outer sides of the headphones 25 to receive the light signal 20. The detected electrical signals of the photodetector 40 are transferred to the receiver 30, which demodulates and reformats the encoded audio signals for transfer to the speakers 35a and 35b. The speakers 35a and 35b are placed in close proximity to the ears of the person 45 wearing the headphones 25.

Wireless transmission of digital data is often accomplished by sending serially formatted frames of the digital data. In systems such as those enumerated by the Infrared Data Association's IrDA “Serial Infrared Physical Layer Specification,” Version 1.4 May, 2001, the frame as shown in section 5.4.2 has a Preamble Field (PA), Start Flag Field (FA), a Data Field (DD), and a Stop Flag Field (STO). The receiver uses the Preamble Field to synchronize the clocking system of the receiver to the in coming message. Generally, a phase lock loop oscillator is used to synchronize the receiver to the Preamble Field.

Once the Preamble Field is detected and the receiver is synchronized, the receiver begins to detect the Start Flag Field to establish symbol synchronization. If the Start Flag Field is correct, the receiver then begins to interpret the-data symbols of the Data Field and will continue to interpret the data symbols until the Stop Flag Field is received.

An illustration of an idealized transmission of digitized data is shown in FIG. 2. During the time period τ₁, a first frame AD0 of symbols of the digital data are created by the sampling of an audio analog signal and converting samples to a digital coding representing the magnitude of the analog signal. The symbols of the frame are interleaved and encoded with an error correction code ECCE0 during the time period τ₂. At this same time τ₂, a second frame AD1 is sampled and converted to symbols of the digital data. During the time period τ₃, the frame of the interleaved and encoded data is used to modulate a transmission signal RF T0, which is broadcast from the transmitter 10 by the LED 15 through the atmosphere to the photodiode 40 of the headphones 25. Ideally this happens instantaneously during the time τ₃. The receiver recovers the transmitted signal and restores the frames of the symbols of received data RF R0. At this same time the second frame of data is interleaved and encoded with the error correction codes ECCE1 and the third sampling AD2 is converted to the digital data. During the fourth time τ₄ the received data RF R0 is deinterleaved and has error correction and detection applied to the received to recover the frames of symbols of the original digital data ECCD0. At this same time, the interleaved and encoded frame of data ECCE1 modulates the transmission signal RF T1, which is transmitted. The transmitted signal RF T1 is received and the frames RF R1 recovered. Simultaneously, the third frames of symbols are interleaved and encoded for error correction and detection to form the frames ECCE2 and a fourth sampling of the analog signal is converted to the frames of symbols AD0 of a second grouping of frames. The frames of symbols of the original data ECCD0 are converted to an analog signal AD0 for application to the speakers 35a and 35b, during the time τ₅. As can be seen the process of acquiring the digital data by sampling the analog signal; interleaving and encoding the digital data with error correction codes; modulating and transmitting the digital data; receiving and recovering the digital data; deinterleaving the digital data and detecting and correcting any errors within the digital data; and converting the digital data to an analog signal for transmission to the speakers 35a and 35b continues sequentially for each of the time periods τ₅, . . . , τₙ.

The “Serial Infrared Physical Layer Specification” details the encoding of the data in section 5.4.1. The digital data is transmitted using a four-pulse position modulation. In this instance a dual-bit data structure is encoded by positioning a pulse within a symbol. The symbol is divided into four time positions of the time duration of the symbol with each position representing the coding of the dual-bit data structure. The Preamble Field, the Start Flag Field, and the Stop Flag Field are each unique codes that have symbol streams that cannot be confused with the four-pulse position modulation of the dual-bit data structure.

The synchronization of the receiver employing a phase lock loop is subject to jitter in pulling the frequency of the local receiver to match the frequency of the transmitted data. Further any drift in the local oscillator causes the local oscillator to have to be re-locked periodically. Without periodic relocking of the local oscillator to the signal, there can be errors with the data reception. Further, multipath reception problems cause the received timing data to fluctuate with the differences in the delay of the paths.

It is known that the clock recovery schemes are not perfect. When the receiver in a wireless environment cannot receive the digital data stream due to interference in the transmission path, the phase lock loop is no longer synchronized to the transmission clock in generating the clock causing corruption or loss of the digital data. Special muting techniques are employed to alleviate the problem of losing the digital data symbols and thus the synchronization of clock.

U.S. Pat. No. 5,457,718 (Anderson, et al.) teaches a compact phase recovery scheme using digital circuits. The phase recovery circuit is essentially a fully integrated digital filter, which interacts with a phase comparator to provide a phase lock loop and data retiming function. The digital filter provides a data retiming function by sending the output of the four bit counter to a digital delay element interposed between the data signal input and the input to the phase comparator. When the data is out of phase with respect to a local clock, the digital filter determines from a multitude of binary phase decisions the polarity of phase correction required, and feeds this back to the delay element. The delay element then adjusts the phase of the incoming data with respect to the phase of the local clock.

U.S. Pat. No. 5,887,040 (Jung, et al.) provides a high speed digital data retiming apparatus, in which, binary data can be retimed in a stable manner, even if static skew due to a delay difference between the retiming clock pulse and the data is present and a dynamic skew due to the characteristic variation according to time and temperature. The external clock pulses are delayed by means of a delaying section, so that system performance is independent of the pattern of data. If the data phases show a continuous difference (wandering) for more than a certain period of time, an elastic buffer absorbs the wandering, and therefore, no data is lost.

U.S. Pat. No. 5,886,552 (Chai, et al.) describes a data retiming circuit, which is capable of more effectively retiming an externally inputted data by using a plurality of clocks from a voltage controlled oscillator of a phase-locked loop.

U.S. Pat. No. 5,608,357 (Ta, et al.) teaches a data retiming system for retiming incoming data and eliminating jitter. The data retiming system includes a local clock; a phase aligner for receiving the incoming data and producing a recovered clock from the incoming data, and then producing retimed incoming data by retiming the incoming data with the recovered clock; and a buffer memory for removing jitter from the retimed incoming data by storing the retimed incoming data to the buffer memory in accordance with the recovered clock and reading the stored data from the buffer memory in accordance with the local clock. The data retiming system provides reliable operation even at very high data rates.

“Low-Latency Plesiochronous Data Retiming,” Dennison, et al., Proceedings of the 1995 Advanced Research in VLSI Conference, March 1995, found Apr. 2, 2002 at www.mit.edu/pub/cva/plesio.ps.Z, retimes received data by delaying the data such that it can be captured by the receiver clock. The delay is varied to allow for the differences from the transmitting clock of the data and the received clock.

“Rational Clocking,” Sarmenta, et al. Proceedings of the International Conference on Computer Design, IEEE, October 1995, describes maintenance of a known phase relationship between clocks whose frequencies are related by a rational factor, and exploits the predictability of their relative phases to algorithmically time communications without run-time arbitration contests.

### SUMMARY OF THE INVENTION

An object of this invention is to provide a communication system that synchronizes data received and recovered from a transmission medium to the data transmitted to the transmission medium.

Another object of this invention is provide a communication system in which the data received and recovered from a transmission medium has neither under-run or overrun of the data due to differences in the transmission clocking and the reception clocking.

To accomplish at least one of these and other objects, a data communication system has a transmitter and a receiver. The transmitter includes a frame formatter and a transmission device. The frame formatter encodes digital data into series of symbols. The encoding of the digital data includes interleaving the digital data and providing error detection and correction codes with the digital data. The transmission device is in communication with the frame formatter to receive the series of symbols and transmits a modulated signal composed of the series of symbols.

The receiver is in communication with the transmitter for acquiring the modulated signal, restoring the modulated signal, reconstructing the symbols of the digital data from the modulated signal and synchronizing the digital data to a first reference signal. The receiver has an amplification and conditioning circuit connected to receive, restore, and sample the modulated signal. The modulated signal is sampled at a multiple of the first reference signal such that transitions representing boundaries between bits of the digital data within the modulated signal are detected and the digital data is reconstructed and synchronized to the second reference signal. Once the amplification and conditioning circuit has reconstructed and synchronized the digital data, the digital data is transferred to a buffer data retention circuit where the reconstructed digital data is retained. The buffer retention circuit has at least one buffer circuit for retaining groupings of the symbols.

The digital data is transferred from the buffer retention circuit to a data correction and deinterleaving circuit for reorganizing the digital data to an original sequence of symbols. The data correction and deinterleaving circuit further corrects any error created in the transmission of the modulated signal. Upon the deinterleaving and correction of the digital data the reorganized and corrected digital data is replaced within the buffer retention circuit.

A boundary marker signal detection circuit is in communication with the amplification and conditioning circuit to receive the reconstructed digital data. From the reconstructed digital data, the boundary marker signal detection circuit extracts a marker signal indicating a boundary of symbols of the digital data. The marker signal provides an indication of the timing of the digital data as broadcasted by the transmitter.

The receiver has a jitter management unit to synchronize the digital data to the first reference signal. The jitter management unit has a first-in-first-out (FIFO) data retention device, which receives the reconstructed digital data at the rate of the first reference signal from the buffer retention circuit and transmits the synchronized digital data for further processing at a rate approximating that of a second reference signal, which approximates the timing of the digital data within the transmitter.

The jitter management unit has a variable reference signal generator connected to the FIFO data retention device to provide the second reference signal for synchronization of the digital data. The buffer data retention circuit transfers the digital data to the FIFO data retention device until the FIFO data retention device contains a first amount of digital data (approximately one half of the capacity of the FIFO data retention device), where upon the FIFO data retention device begins to transmit the digital data. Further, the buffer data retention circuit must transfer all symbols of the digital data present between two marker signals to prevent overrun of the digital data. To accomplish this full transfer of all symbols between two markers, the buffer data retention device transfers the first and second symbols of a frame between two markers essentially simultaneously. This prevents any overrun of the data as transferred to the FIFO data retention circuit.

The jitter management unit has a generator control circuit connected to receive a marker signal extracted from the modulated signal by the boundary marker signal detection circuit. The generator control circuit is further in communication with the FIFO data retention device to receive an occupation signal indicating an amount of digital data present within the FIFO data retention device. From the marker signal and the occupation signal, the generator control circuit creates a generator control signal to cause an adjustment of the variable reference signal generator such that the second reference signal synchronizes the digital data to a timing at which the digital data is transmitted.

The generator control circuit causes the generator control signal to indicate that there is to be no adjustment by the variable reference signal generator to the second reference signal, if the occupation signal indicates that the FIFO data retention device contains a second amount (approximately half the capacity of the FIFO data retention device) of the digital data. However, if the occupation signal indicates that the FIFO data retention device contains less than the second amount of the digital data, generator control circuit sets the generator control signals to cause adjustment by the variable reference signal generator to the second reference signal to increase the contents of the FIFO data retention device until it contains the second amount of digital data. Alternately, if the occupation signal indicates that the FIFO data retention device contains greater than the second amount of the digital data, the generator control circuit causes the generator control signal to indicate that the variable reference signal generator should cause adjustment to the second reference signal to decrease the contents of the FIFO data retention device until it contains the second amount of digital data.

### BRIEF DESCRIPTION OF THE DRAWINGS

FIG. 1 is a diagram of a communications system of the prior art.

FIG. 2 is a timing diagram of ideal transmission of digital data through a communications system of the prior art.

FIG. 3 is a diagram of the communication system of this invention.

FIG. 4 is a block diagram of the transmitter of the communication system of this invention.

FIG. 5 is a diagram of the frame structure of the digital data of the communication system of this invention.

FIG. 6 is a block diagram of the receiver of the communication system of this invention.

FIGS. 7a-7d are flow diagrams describing the method for synchronizing data received by a receiver to prevent overrun or under-run of the digital data to during transmission of the digital data to the receiver of this invention.

FIG. 8a is a timing diagram illustrating the synchronization of the digital data in a communication system of this invention.

FIG. 8b is a timing diagram illustrating the relationship of the marker signal with synchronization signal and the start signal of the communication system of this invention.

FIG. 9 is a timing diagram illustrating the transfer of data to the FIFO data retention device of this invention.

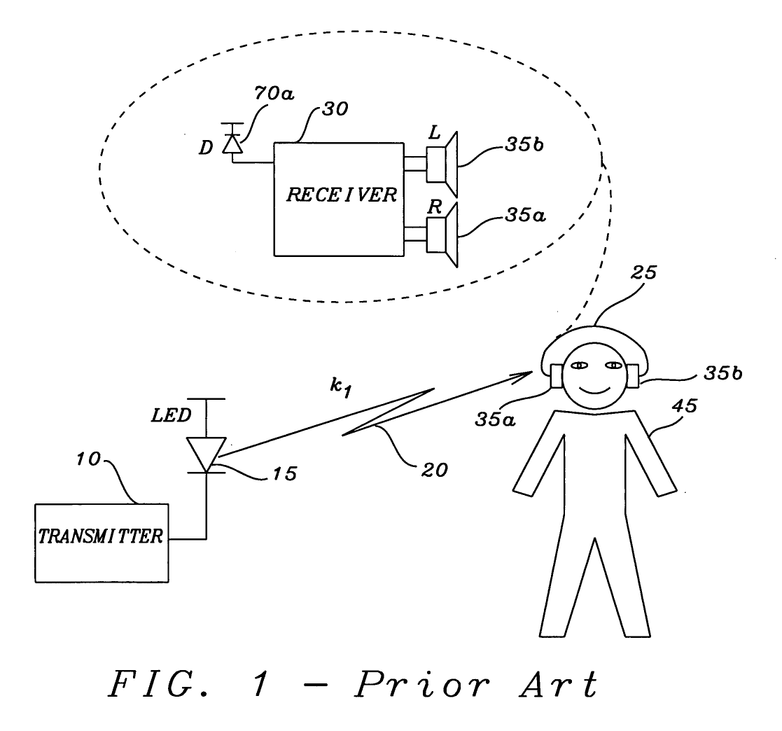

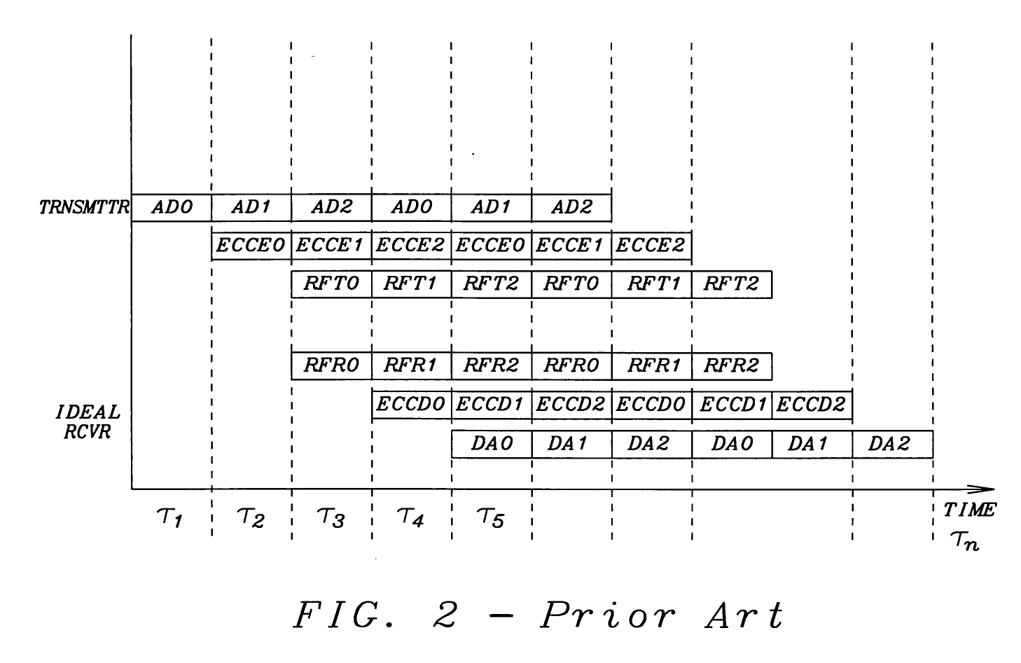

### DETAILED DESCRIPTION OF THE INVENTION

The communication system of this invention is applicable either to wired or wireless digital audio communication and provides isochronous timing of the digital data for high quality audio playback. Both the transmitter and receiver will use their own local clocks for the communication. In addition the receiver contains a jitter management unit that consists a first-in-first-out (FIFO) data retention device or buffer, a standard VCXO (Voltage controlled crystal oscillator) and a VCXO control logic unit. This jitter management unit tracks the transmitter's audio clock by making use of the FIFO buffer status only and is simple to implement or integrate into any digital audio systems that separates the playback from the source.

The FIFO buffer is analogous to a container and the producer (receiver) pours in digital data symbols of the analog audio signal at a rate that is equivalent to the receiver's clock period. This container is empty at the beginning and the consumer (player) will not start until the digital data symbols have reached a threshold level. Once the digital data symbols reach the threshold level, the consumer begins to consume the digital data symbols. If theoretically the producer and consumer operate at the same rate, then the level of the FIFO buffer or container will be at the threshold level always because what gets in also gets out at the same rate.

If however, the producer happens to be faster and the digital data symbols are transferred to the FIFO buffer more quickly and the consumer is still extracting the digital data at a slower rate, the level of the container or FIFO buffer increases. As this increase in the level of the FIFO buffer continues, the FIFO buffer will overflow and an overrun of the digital data symbols will cause a loss in the digital data. Alternately, if the producer happens to be slower than the consumer and the digital data symbols are transferred to the FIFO buffer more slowly and the consumer is still extracting the digital data at a faster rate, the level of the container or FIFO buffer decreases. As this decrease in the level of the FIFO buffer continues, the FIFO buffer will empty and an under-run of the digital data symbols will cause the playback to stop until the producer provides more of the digital data symbols, thus causing distortion during the playback of the isochronous digital data symbols.

If the FIFO buffer has indicators demarcating regions denoting the level digital data symbols present within the FIFO buffer, the consumer can adjust the rate at which the digital data symbols are removed from the FIFO buffer. If a central region between an upper limit and a lower limit are designated a “comfort zone,” the consumer does not change the rate at which the digital samples are removed from the FIFO buffer. However, when the level of the amount of data present within the FIFO buffer exceeds either the upper limit or the lower limit, the consumer must now either increase or decrease the rate of consumption of the digital data symbols from the FIFO buffer.

For example, if the producer is providing the digital data symbols to the FIFO buffer faster than the consumer is extracting these digital data symbols, the FIFO buffer will exceed the upper limit and the amount of digital data symbols in the FIFO buffer are no longer in the “comfort zone”. To prevent the container from overfilling and digital data symbols from being lost, the consumer will increase the consumption rate to match the rate of transfer of the producer and attempts to have the amount of digital data symbols present in the FIFO buffer approach the comfort zone again. The consumer increments the rate of transfer from the FIFO buffer while monitoring the level of the amount of digital data present in the FIFO buffer at periodic intervals. The consumer increments the rate of consumption of the digital data in steps to a stage that-the amount of data present in the FIFO buffer starts to fall, then the consumer stops incrementing the rate of transfer and waits for the level of the amount of digital data symbols in the FIFO buffer to enter the comfort zone. If however, the producer is transferring the digital data at a rate that is much larger than the consumer can anticipate, the FIFO buffer may enter into a hard upper region. Once the amount of digital data symbols present in the FIFO buffer has entered into the hard upper region, the consumer must then increment the transfer rate much faster. This acceleration and deceleration by the consumer of the transfer rate will leads to the consumer's speed being close to the producer's speed.

The consumption rate of the digital data symbols from the FIFO buffer by the consumer will not be exactly the same as the transfer rate of the producer but the consumer will ultimately have a consumption rate that is in the soft region or comfort zone and there will be little acceleration or deceleration of the consumption rate.

It is apparent that the same principle applies to the producer transferring the digital data symbols to the FIFO buffer at an initially slower rate than the consumption rate of the consumer. The consumer slows the consumption rate incrementally until the amount of digital data symbols within the FIFO buffer approach the comfort zone.

Refer now to FIG. 3 for a discussion of the communication system of this invention. An analog signal such as human speech or music is sampled and converted into digital data symbols 50 representing the samples of the analog signal. The digital data symbols 50 are transferred to the transmitter 100, which serializes and formats the digital data symbols and provides error detection and correction codes. The encoded digital data symbols are then used to modulate a transmission signal such as a fundamental frequency for an RF wireless transmission or a light signal for an infrared transmission. The modulated signal 150 is transferred to the receiver 200, which recovers, restores, deserializes, and synchronizes the digital data symbols. The receiver 200 further converts the digital data symbols to the analog signal 250 for transfer to the speakers of the headphones 260.

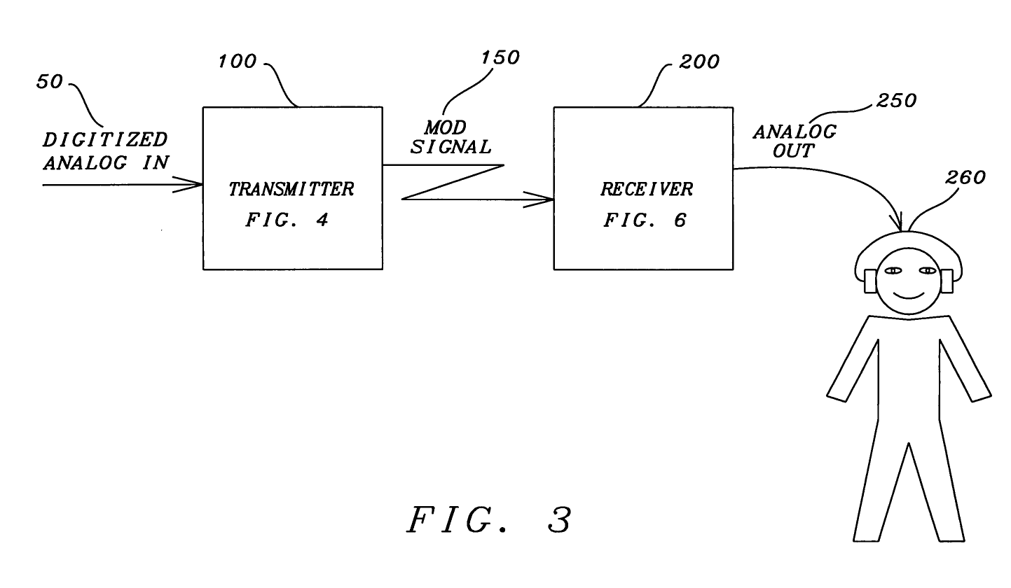

The transmitter 100 of this invention is shown in FIG. 4. The digital data symbols 50 are transferred to the data input register 105. The digital data register 105 synchronizes the digital data symbols with the data clock provided by the transmitter clock generator 135. The digital data symbols are transferred from the data input register 105 to the error detection and correction coding circuit 110 where the digital data symbols are encoded with error detection and correction codes to provide a level of recovery for potential corruption of the transmitted digital data symbols.

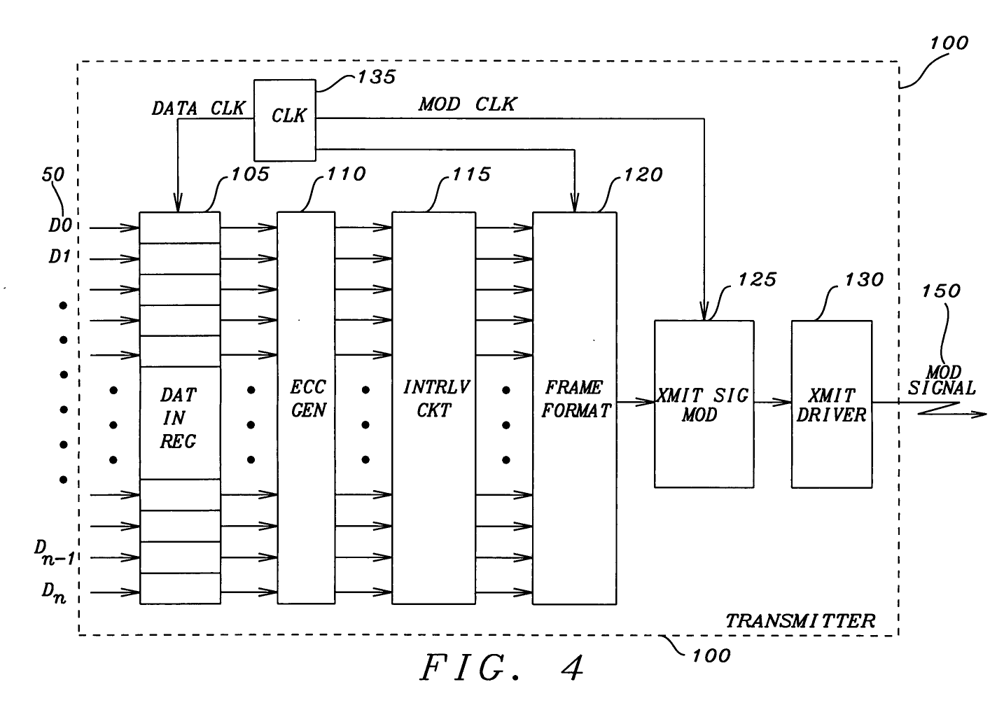

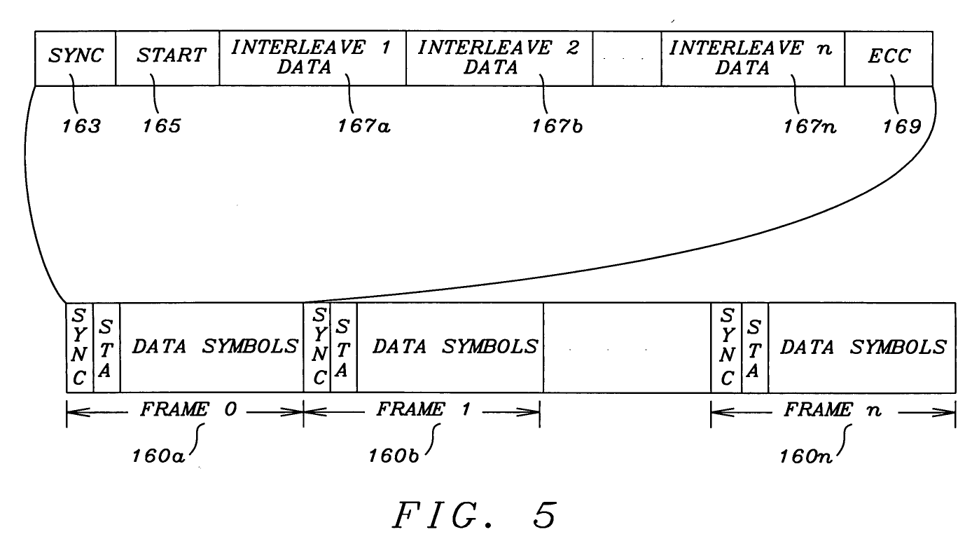

The digital data symbols with their attendant error correction codes are then transferred to the interleave circuit 115. As is known in the art, the transmission of digital data symbols often have corruption of the transmission that occurs such that temporally adjacent digital data symbols maybe corrupted. To alleviate this problem, the digital data symbols are interleaved such that digital data symbols of the same error correction code are no longer temporally adjacent, thus permitting correction of any of the corruption at the receiver of the digital data symbols. The interleaved digital data symbols with the error correction codes are then transferred to the frame formatting circuit 120. The frame formatting circuit serializes the interleaved digital data symbols and then generates the necessary synchronization field and a start pattern that are appended to the serialized interleaved digital data symbols with the attendant error correction codes as shown in FIG. 5.

Each frame 160a, . . . , 160n begins with a synchronization pattern 163. The synchronization pattern 163 is a unique series of timing pulses that in a receiver of the prior art would be used to synchronize a phase locked loop. Following the synchronization pattern 163 is a start sequence 165 indicating that the pattern of signals that follows represents the packets 167a, . . . ,167n digital data symbols. In a communication system where the frames have a fixed number of packets 167a, . . . , 167n of the interleaved digital data symbols, the start sequence 165 provides a reference timing referenced to the transmitter clock 135 of FIG. 4. Appended at the end of the frame is the error correction coding 169 that is used to repair and recover any of the digital data symbols corrupted in the transmission.

The formatted digital data symbols are transferred from the frame formatter 120 to the transmit signal modulator 125. In an infrared transmission system, the modulation scheme is usually a four-pulse position modulation scheme, but any appropriate modulation scheme is in keeping with the intention of this invention. The transmitter clock generator 135 provides that necessary timing to create the four-pulse position modulation. The modulated transmit signal is transferred to the transmit driver 130 which sends the modulated signal 150 to a transducer such as an LED which conveys the modulated signal to a transmission medium such as the atmosphere or a cabling such as a fiberoptic cable.

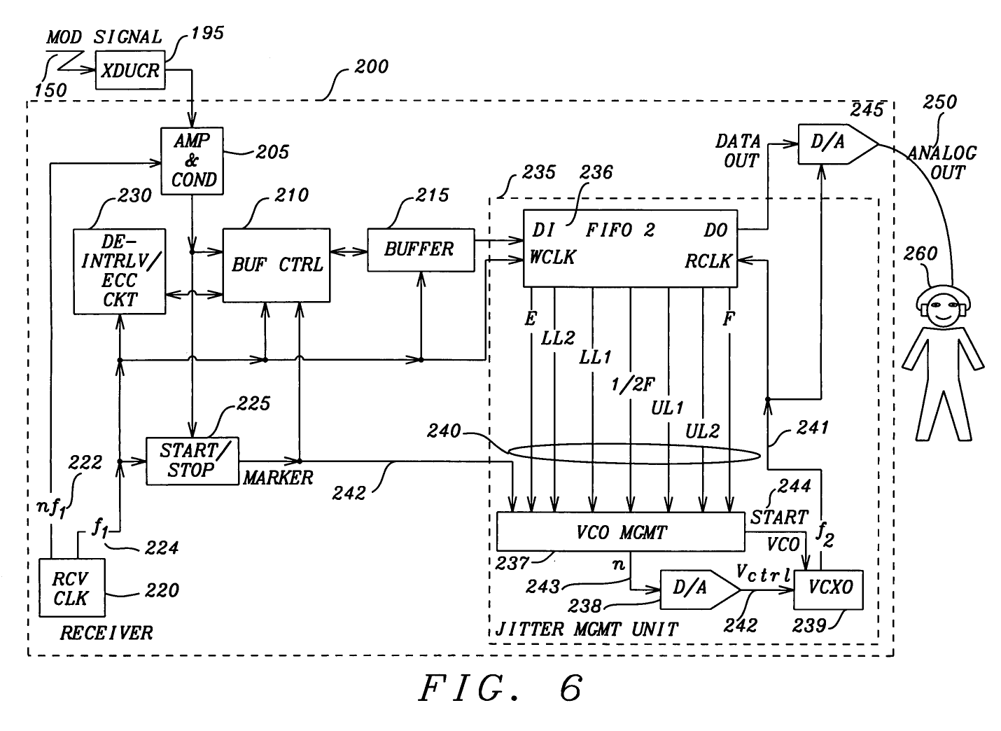

Return now to FIG. 3. The modulated signal 150 is transported through the transmission medium to the receiver 200. Refer now to FIG. 6 for a discussion of the receiver of this invention. The modulated signal impinges upon a transducer 195. In the case of an infrared system the transducer 195 would be a PIN diode receiving a light signal. In the case of an RF system the radio frequency wave, the transducer 195 would be an antenna. The electrical signal developed by the transducer 195 is then transferred to the amplification and conditioning circuit 205. The amplification and conditioning circuit 205 restores the amplitude of the modulated signal, removes any extraneous noise, and demodulates the signal to recover the digital data symbols.

In the preferred embodiment, the restored and conditioned modulated signal is sampled using a clock that a multiple factor (n) of a receive clock f₁. The receive clock f₁ and its multiple nf₁ are generated by the receiver clock generator 220, which has a fundamental frequency approaching that of the transmitter clock generator 135 of FIG. 4. For instance in an implementation of the preferred embodiment the transmitter clock generator 135 and the receiver clock generator 220 each have a frequency of 12.288 MHz+/−50 ppm. The differences in the frequency due to the tolerance and the differences in the phase between the two clock generators causes the overrun and under-run of the digital data symbols as discussed above.

The higher frequency multiple nf₁ provided by the receiver clock generator 220 is used to detect the transitions of the modulated signal and allows the determination of the synchronization pattern 163 and the start pattern 165 of the modulated signal, as shown in FIG. 5. The amplification and conditioning circuit 205 then detects the packets 167a, . . . , 167n of the interleaved digital data symbols and extracts the packets of the interleaved digital data symbols from the modulated signal. The multiple n of the multiple frequency clock nf₁ is optimally from approximately 5 times to approximately 6 times the frequency of the receiver clock f₁. Other frequencies of sampling the modulated signal or other methods for extracting the packets of the interleaved digital data symbols maybe employed by the amplification and conditioning circuit 205 and still be in keeping with the intent of this invention.

The fully recovered frame of the packets of the interleaved digital data symbols are transferred from the amplification and conditioning circuit 205 to the start/stop detection circuit 225. The start/stop detection circuit 225 interprets the synchronization pattern and the start pattern to develop a marker signal 242. The marker signal 242 is timed to demarcate the boundaries of the beginning of each frame of the packets 167a, . . . , 167n of the interleaved digital data symbols. This timing is equivalent to the periodicity of the transmitter clock generator 135 of FIG. 4.

The recovered packets of the interleaved digital data symbols are transferred from the amplification and conditioning circuit 205 to the buffer control circuit 210. The buffer control circuit 210 places the packets of the interleaved digital data symbols in the buffer 215. The buffer control circuit 210 directs the placement and movement of the packets of the digital data symbols into and out of the buffer 215.

The buffer control circuit 210 extracts the packets of the interleaved digital data symbols from the buffer 215 for transfer to the deinterleave and error detection and correction circuit 230. The deinterleave and error detection and correction circuit 230 rearranges the order of the packets of digital data symbols to their original order. The packets of digital data symbols are then examined for errors that may occur during the transmission of the modulated signal and then corrected to restore the digital data symbols as transmitted. The deinterleaved and corrected packets of digital data symbols are then returned to the buffer 215 by the buffer control circuit 210.

The packets of digital data symbols must be transferred isochronously to insure that the audio analog signal 250 applied to the headphones 260. To insure this, the packets of digital data symbols must be consumed at the rate at which they were generated using the transmitted clock. Since the frequency and phase of the receiver clock 220 varies from the transmitter clock 135 of FIG. 4, the packets of digital data symbols must be resynchronized to match the transmitter clock to insure the isochronous transfer to the packets of digital data symbols. The packets of digital data symbols are transferred from the buffer 215 to the jitter management unit 235 for the resynchronization to the transmitter clock.

The buffer control circuit 210 conveys the packets of digital data symbols from the buffer 215 to the FIFO buffer 236. The packets of digital data symbols are transferred from the buffer 215 to the FIFO buffer 236 at the rate determined by the frequency f₁ of the receiver clock generator 220. The FIFO buffer 236 is structured to have the digital data symbols written at one frequency (WCLK) and read at another frequency (RCLK). The receiver clock generator 220 is connected to the write clock terminal WCLK of the FIFO buffer 236 to provide the timing for the transfer of the digital data symbols to the FIFO buffer 236.

The digital data symbols are transferred in isochronous order from the FIFO buffer 236 at the frequency f₂ to the digital-to-analog converter 245. The digital data symbols are converted by the digital-to-analog converter 245 to the audio analog signal 250. The audio analog signal 250 is transmitted to the speakers of the headphones 260.

The voltage-controlled oscillator (VCXO) 239 is connected to the read clock terminal RCLK of the FIFO buffer 236 to provide the frequency f₂ with the Read Clock 242. The read clock RCLK as controlled by the frequency f₂ acts as the consumer control for the FIFO buffer 236 as described above. The frequency f₂ is controlled through the VCXO by the control voltage 242. The control voltage 242 is the output of a second digital-to-analog converter 238, which is controlled by the voltage control word 243. The voltage control word 243 is generated by the VCO management circuit 237 and is dependent on the FIFO level indication signals 240 and the marker signal 242.

The FIFO level indication signals 240 provide a signal denoting the level of the FIFO 236 such that the consumer regulation by the adjustment of the frequency of the VCXO 239 can be determined by the VCO management circuit 237. In the preferred embodiment, there are seven indicators 240 of the level of the FIFO 236—Empty E, Lower level 2 LL2, Lower Level LL1, half full ½ F, Upper Limit 1 UL1, Upper Limit 2 UL2, and Full F.

If the FIFO level indication signals 240 indicate that the FIFO buffer 236 is either full F or empty E, there is an error in the synchronization of the digital data symbols. The jitter management unit 235 must then perform appropriate diagnostic to correct the error condition. In normal operation, the FIFO level indication signals 240, the frequency f₂ is to be adjusted to maintain the amount of digital data symbols present in FIFO buffer in the region between the levels indicated by the Lower Level LL1 and the Upper Limit 1 UL1 signals.

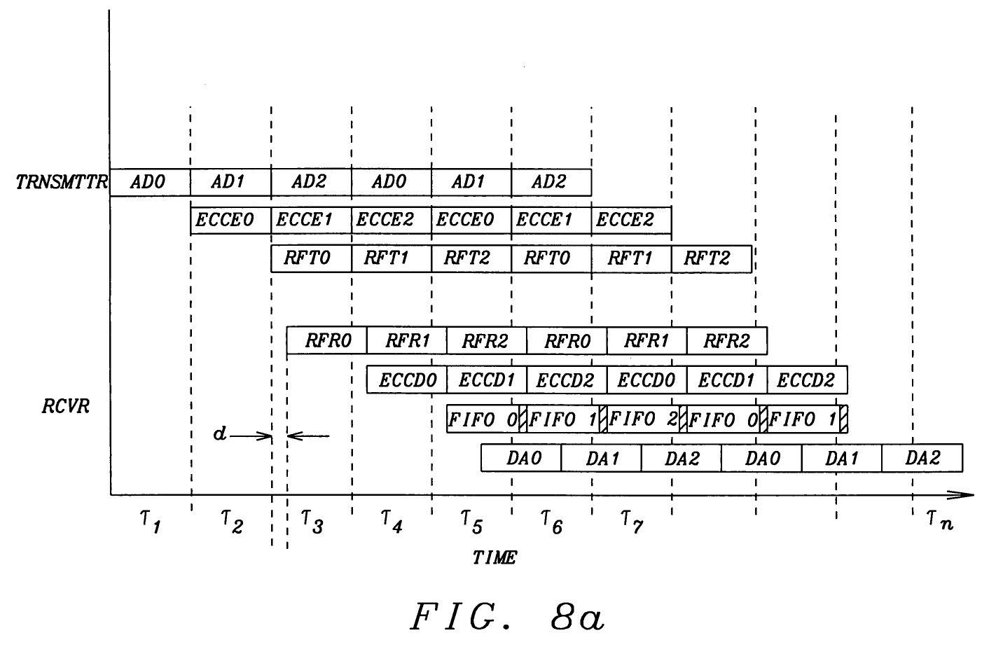

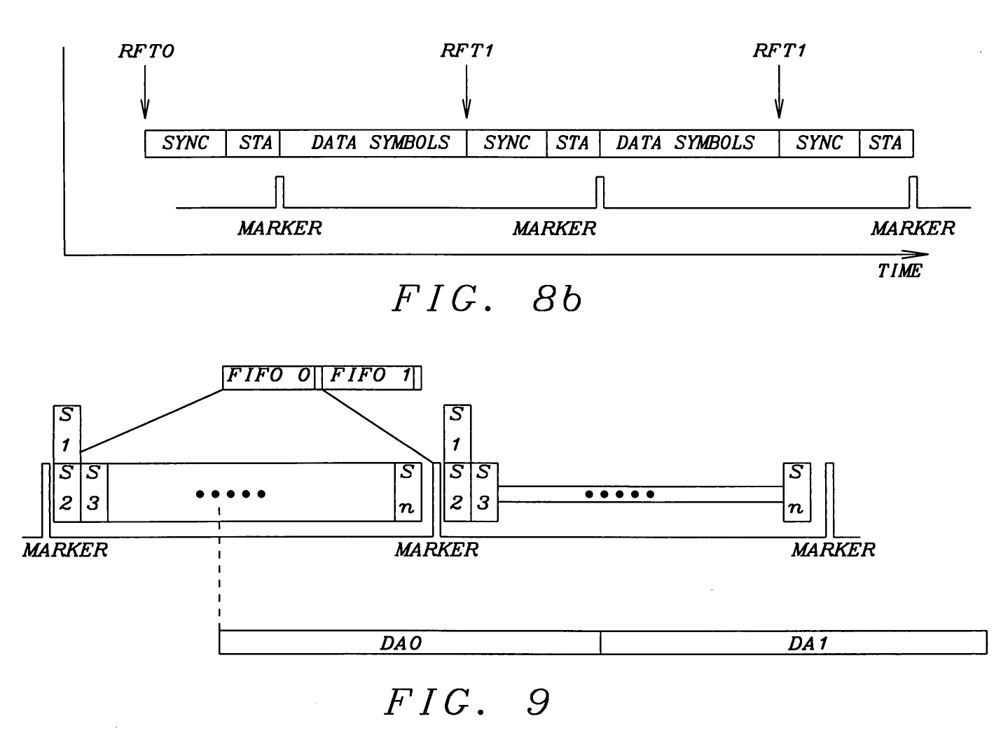

Refer now to FIGS. 4 and 8a for a discussion of the operation of the transmitter 100 of this invention. During the time period τ₁, a first frame AD0 of symbols of the digital data are created by the sampling of an analog signal and converting samples to a digital coding representing the magnitude of the analog signal. The digital data symbols 50 are then placed in the data input register 105 of the transmitter 100. The symbols of the frame are encoded with an error correction code ECCE0 by the ECC generator 110 and interleaved by the interleave circuit 115 during the time period τ₂. At this same time τ₂, a second frame AD1 is sampled and converted to symbols of the digital data and placed in the data input register 105. During the time period τ₃, the frame formatter 120 formats the frame of the encoded and interleaved data. At this same time the second frame of data is interleaved and encoded with the error correction codes ECCE1 and the third sampling AD2 is converted to the digital data. Within each of the time periods τ₄, . . . , τₙ the analog signal is sampled and a new set of digital data symbols is created and transferred to the data input register 105. At each following time period τ₄, . . . , τₙ, the data is encoded with an error correction code ECCEn by the ECC generator 110 and interleaved by the interleave circuit 115. Then in the subsequent time period τ₄, . . . , τₙ, the frame formatter 120 formats the encoded and interleaved data to create the frames for transmission. During this period the formatted frames modulate the transmit signal with in the transmit signal modulator 125, which is used by the transmit driver 130 to convey the modulated signal 150 to the transmission medium.

Refer now to FIGS. 6 and 8a for a discussion of the operation of the receiver of this invention. As the modulated signal 150 traverses the transmission medium, the modulated signal is delayed by an amount of time δ. Further the quality of the transmission medium maybe such that the modulated signal 150 is attenuated and interfered with to cause corruption of the modulated signal 150. The receiver 200 recovers the modulated signal and restores the frames of the symbols of received data RF R0 during the time period τ₃. The transducer 195 acquires the modulated signal 150 from the transmission medium, converts the modulated signal 150 to an electrical signal that is applied to the amplification and conditioning circuit 205. The amplification and conditioning circuit 205, as described above restores, samples, and recovers the digital data symbols RF R0, which are placed in the buffer 215.

During the fourth time period τ₄ the received data RF R0 is has error correction and detection applied and is deinterleaved by the deinterleave and error detection and correction circuit 230 to recover the frames of symbols of the original digital data ECCD0. At this same time the transmitted signal RF T1 is received and the frames RF R1 recovered. The frames of symbols of the original data ECCD0 are placed in the FIFO buffer 236 of the jitter management unit 235, during the time period τ₅. The digital data symbols are then synchronized to the timing of the transmitter clock and applied during the time period τ₅ to the digital-to-analog converter 245 and then transmitted as the audio analog signal 250 to the headphones 260.

In each of the time periods τ₄, . . . , τₙ the modulated signal is acquired and the transmitted signal is recovered. The frames of the digital data symbols are extracted and the digital data symbols have error detection and correction applied to them. The digital data symbols are then transferred to the FIFO buffer 236 where they are synchronized to their original isochronous transmission timing. The digital data symbols are then applied to the digital-to-analog converter 245 for transmission to the headphones 260.

The start/stop detection circuit 225 is connected to the buffer control circuit 210 such that the marker signal 242 is transmitted to the buffer control circuit 210. The buffer 210 is formed of multiple frame buffers into which one frame is placed upon receipt and recovery of the frames of digital data symbols. When a frame of digital data symbols (for instance frame ECCD0) have been deinterleaved and corrected and returned to the buffer 215, they are ready to be placed in the FIFO buffer 236.

Referring to FIG. 8b, the marker signal is created at the completion of the synchronization signal and the start signal for each frame of the digital data symbols. Since the marker occurs at the beginning boundary of a frame of digital data symbols, the marker is synchronized to the transmitter clock and can be used as an indication of the synchronicity of the transmitter and receiver clock. In the preferred embodiment, the frames of digital data symbols have a fixed number of frames, the timing between the marker signals is also fixed and locked to a frequency that is a sub-multiple of the transmitter clock.

Returning now to FIG. 6, upon receipt of a marker signal 242, the buffer control circuit 210 initiates the transfer of the frame of digital data symbols to the FIFO buffer 236. Since there is no real indication or control of the difference between the frequency of the transmitter clock generator 135 of FIG. 3 and the frequency f₁ of the receiver clock generator 220, the transfer of the frame of the digital data symbols must occur between two marker signals 242 as shown in FIG. 8b. To guarantee this transfer, the buffer control circuit 210 initiates the transfer of frame of digital data symbols by relatively simultaneously transferring the first two digital data symbols S1 and S2 from the buffer 215 to the FIFO buffer 236, as shown in FIG. 9. The remaining digital data symbols S3, . . . , Sn of the frame are transferred serially at the frequency f₁ of the receiver clock generator 220. When the level indicator signal 240 indicates that the FIFO buffer 236 is half full (the half full indicator ½ F is active), the VCO management circuit 237 activates the Start VCO signal 244 to start the VCXO 239 to provide the Read Clock signal 242 to the FIFO buffer 236, to begin the streaming of the digital data symbols DA0 of FIG. 9 to the digital-to-analog converter 245.

The digital data symbols S3 and Sn continue to be transfer into the FIFO buffer 236 until the completion of the frame. When the next marker signal 242 indicates the detection of the start pattern, the first two symbols S1 and S2 of the second frame are transferred to the FIFO buffer 236. The remaining digital data symbols S3 and Sn are then transferred to FIFO buffer 236 prior to the next subsequent marker signal 242.

The transfer of the digital data symbols from the FIFO buffer 236 continues with no change in the frequency f₂ of the. VCXO 239 while the amount of digital data symbols retained in the FIFO buffer 236 remains between the, Lower Level LL1 and the Upper Limit 1 UL1. Once the amount of digital data symbols exceeds the Upper Limit UL1 or the Lower Limit LL1, the FIFO indicator signals 240 are appropriately activated to indicate the level. The VCO management circuit 237 increments or decrements the voltage control word 243 to cause to cause the digital-to-analog converter 238 to increase or decrease the VCO control voltage 242. The VCXO 239 will then increase or decrease the frequency f₂ of the Read Clock signal 241.

When an increase in the amount of digital data symbols present in the FIFO causes the Upper Limit UL1 FIFO indicator signal 240 to be activated, the VCO management circuit 237 increments the voltage control word 243 such that the digital-to-analog converter causes the VCO control voltage 246 to increase, thus causing the frequency f₂ to increase. This causes the rate of consumption of the digital data symbols from the FIFO buffer 236 to increase. The VCO management circuit 237 monitors the activity of the FIFO indicator signals 240 to determine a gradient of the change in the amount of digital data symbols present within the FIFO buffer 236. If the Upper Limit UL1 of the FIFO indicator signals 240 indicates that the amount of data present within the FIFO buffer 236 still exceeds the Upper Limit UL1, the VCO management circuit 237 increments the voltage control word 243 to cause the frequency f₂ to increase again to increase the rate of consumption. Alternately, if the Upper Limit UL1 of the FIFO indicator signals 240 indicates that the amount of data present within the FIFO buffer 236 no longer exceeds the Upper Limit UL1, but the half full indicator ½ F is activated, the VCO management circuit 237 does not change the voltage control word 243 and the frequency f₂ maintains a constant rate of consumption. However, if the Upper Limit UL1 of the FIFO indicator signals 240 is no longer active to indicate that the amount of data present within the FIFO buffer 236 does not exceed the Upper Limit UL1, but the half full indicator ½ F indicates that the gradient of the decrease of the amount of data present within the FIFO buffer 236 is too large, the VCO management circuit 237 decrements the voltage control word 243 to cause the frequency f₂ to decrease to reduce the rate of consumption of the digital data symbols from the FIFO buffer 236.

If the difference between the frequency f₁ of the receiver clock generator 220 is greater than the frequency f₂ of the Read Clock signal 241 such that the amount of digital data symbols within the FIFO buffer 236 rises so that the Upper Limit signal UL2 of the FIFO indicator signals 240 is activated, the VCO management circuit 237 changes the voltage control word 243 by a double factor such that the frequency f₂ of the VCXO 239 increases by a double increment. This causes the consumption from the FIFO buffer 236 to increase at a faster rate to cause the amount of digital data symbols present within the FIFO buffer 236 to fall toward the half full level. The VCO management circuit 237 monitors the gradient of the change of the amount of digital data symbols present within the FIFO buffer 236. If the gradient of the change of the amount of the digital data symbols is too large, the VCO management circuit 237 decreases the voltage control word 243 to cause the frequency f₂ to decrease. This slows the consumption rate of the digital data symbols from the FIFO buffer 236.

When a decrease in the amount of digital data symbols present in the FIFO buffer 236 causes the Lower Limit LL1 FIFO indicator signal 240 to be activated, the VCO management circuit 237 decrements the voltage control word 243 such that the digital-to-analog converter causes the VCO control voltage 246 to decrease, thus causing the frequency f₂ to decrease. This causes the rate of consumption of the digital data symbols from the FIFO buffer 236 to fall. The VCO management circuit 237 monitors the activity of the FIFO indicator signals 240 to determine a gradient of the change in the amount of digital data symbols present within the FIFO buffer 236. If the Lower Limit LL1 of the FIFO indicator signals 240 indicates that the amount of data present within the FIFO buffer 236 still exceeds the Lower Limit LL1, the VCO management circuit 237 decrements the voltage control word 243 to cause the frequency f₂ to decrease again to decrease the rate of consumption. Alternately, if the Lower Limit LL1 of the FIFO indicator signals 240 indicates that the amount of data present within the FIFO buffer 236 no longer exceeds the Lower Limit LL1, but the half full indicator ½ F is activated, the VCO management circuit 237 does not change the voltage control word 243 and the frequency f₂ maintains a constant rate of consumption. However, if the Lower Limit LL1 of the FIFO indicator signals 240 is no longer active to indicate that the amount of data present within the FIFO buffer 236 does not exceed the Lower Limit LL1, but the half full indicator ½ F indicates that the gradient of the decrease of the amount of data present within the FIFO buffer 236 is too large, the VCO management circuit 237 decrements the voltage control word 243 to cause the frequency f₂ to decrease to reduce the rate of consumption of the digital data symbols from the FIFO buffer 236.

If the difference between the frequency f₁ of the receiver clock generator 220 is greater than the frequency f₂ of the Read Clock signal 241 such that the amount of digital data symbols within the FIFO buffer 236 falls so that the Lower Limit signal LL2 of the FIFO indicator signals 240 is activated, the VCO management circuit 237 changes the voltage control word 243 by a double factor such that the frequency f₂ of the VCXO 239 decreases by a double decrement. This causes the consumption from the FIFO buffer 236 to decrease at a faster rate to cause the amount of digital data symbols present within the FIFO buffer 236 to fall toward the half full level. The VCO management circuit 237 monitors the gradient of the change of the amount of digital data symbols present within the FIFO buffer 236. If the gradient of the change of the amount of the digital data symbols is too large, the VCO management circuit 237 decreases the voltage control word 243 to cause the frequency f₂ to decrease. This slows the consumption rate of the digital data symbols from the FIFO buffer 236.

The VCO management circuit 237 constantly monitors the FIFO indicator signals 240 to determine the amount of digital data symbols present within the FIFO buffer 236 and the gradient of the change in consumption of the digital data symbols. From the FIFO indicator signals 240 and the calculated gradient, the VCO management circuit 237 adjusts the voltage control word 243 to cause the frequency f₂ of the Read Clock 241 to maintain the level of the amount of digital data symbols within FIFO buffer 236 at approximately the half full level (½ F).

The number of bits n of the voltage control word 243 provided to the digital-to-analog converter 238 essentially determines the sensitivity of the jitter management unit 235. In an implementation of the preferred embodiment, the voltage control word 238 has 3 bits allowing eight increment of the control voltage 242 from the digital-to-analog converter 238. The sensitivity would be improved by selecting 8 bits for the voltage control word 238 that would have 256 increments of the control voltage 242. Further, the number of FIFO level indication signals 240 could be increased to provide a finer grained indication of the FIFO level indication signals 240.

If the modulated signal 150 is too severely corrupted that the Start/Stop circuit 225 is unable to determine the synchronization field and the start pattern, the buffer control circuit 210 destroys the recovered data and placed appropriate null characters within the buffer 215. The null characters, when transferred to the FIFO buffer 236, act to flush the FIFO buffer 236. The VCO management circuit 237 interprets this as an error (Empty indicator E is activated) and causes the VCXO 239 to stop the Read Clock 241 thus deactivating the digital-to-analog converter 245 causing the audio analog signal 250 to be muted. When the synchronization field and the start pattern are reestablished, the digital data symbols are then transferred as above described.

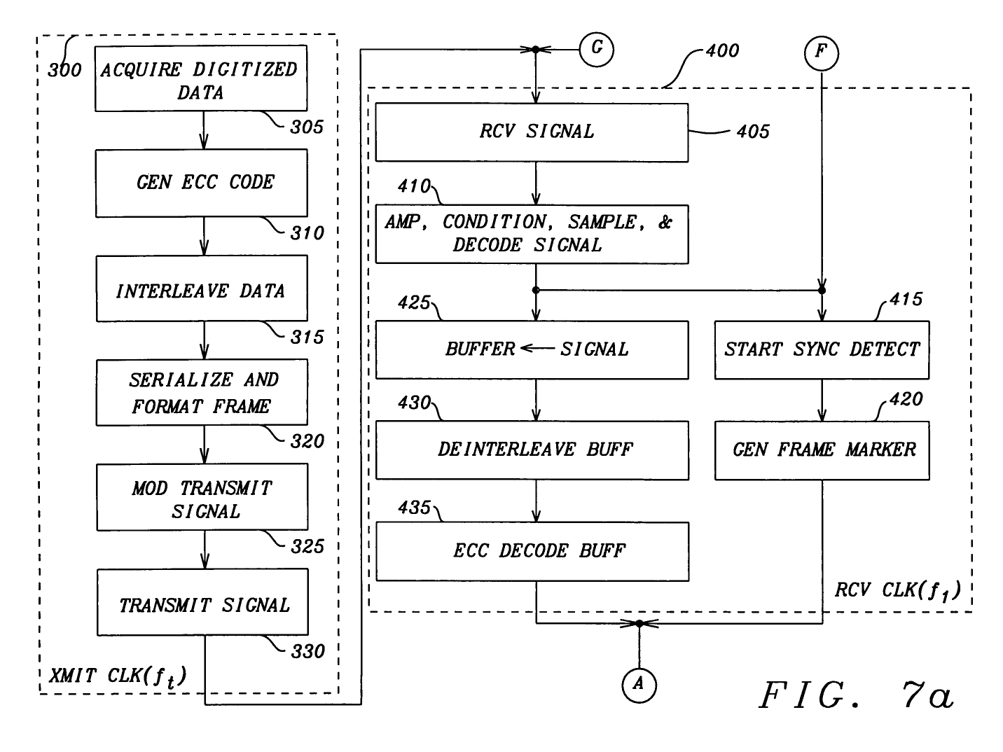

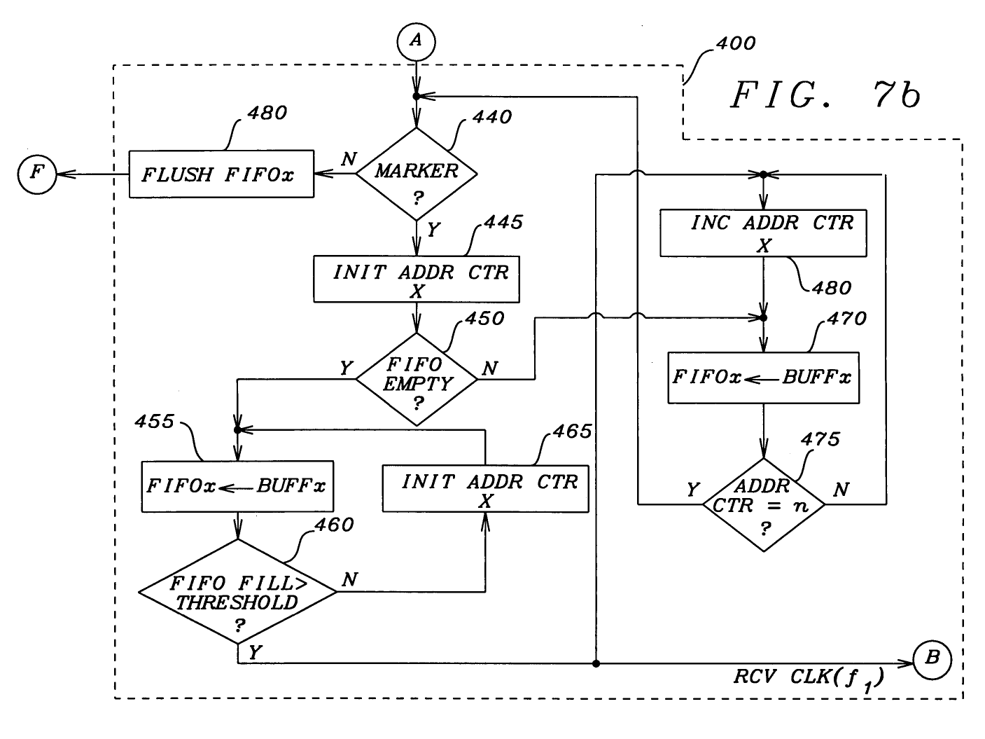

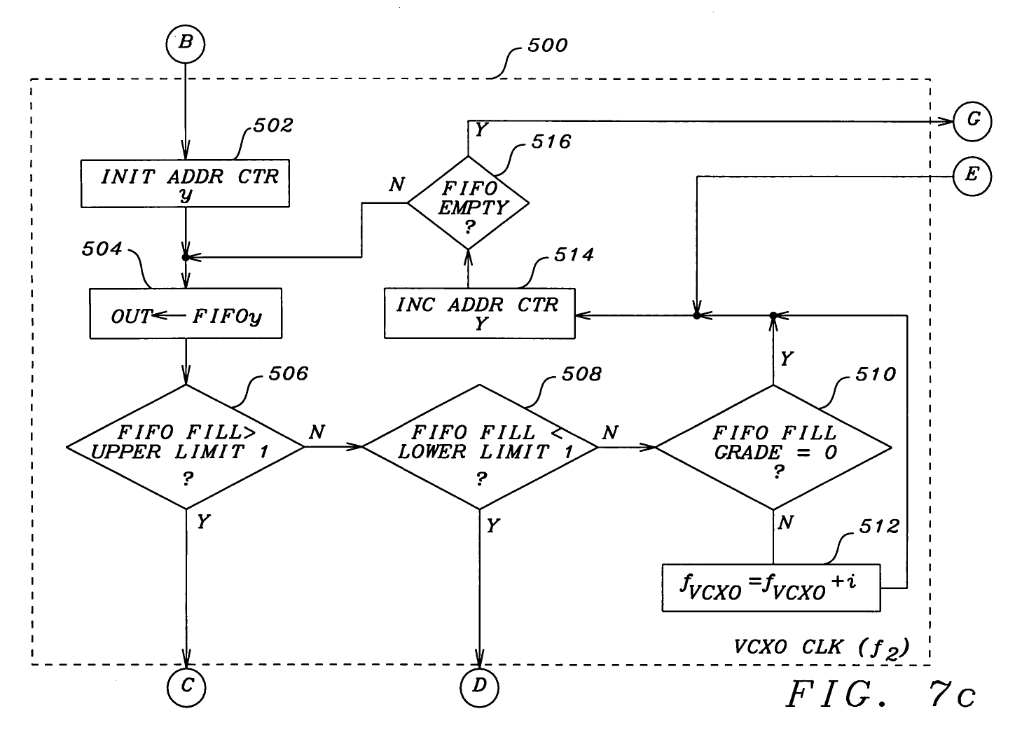

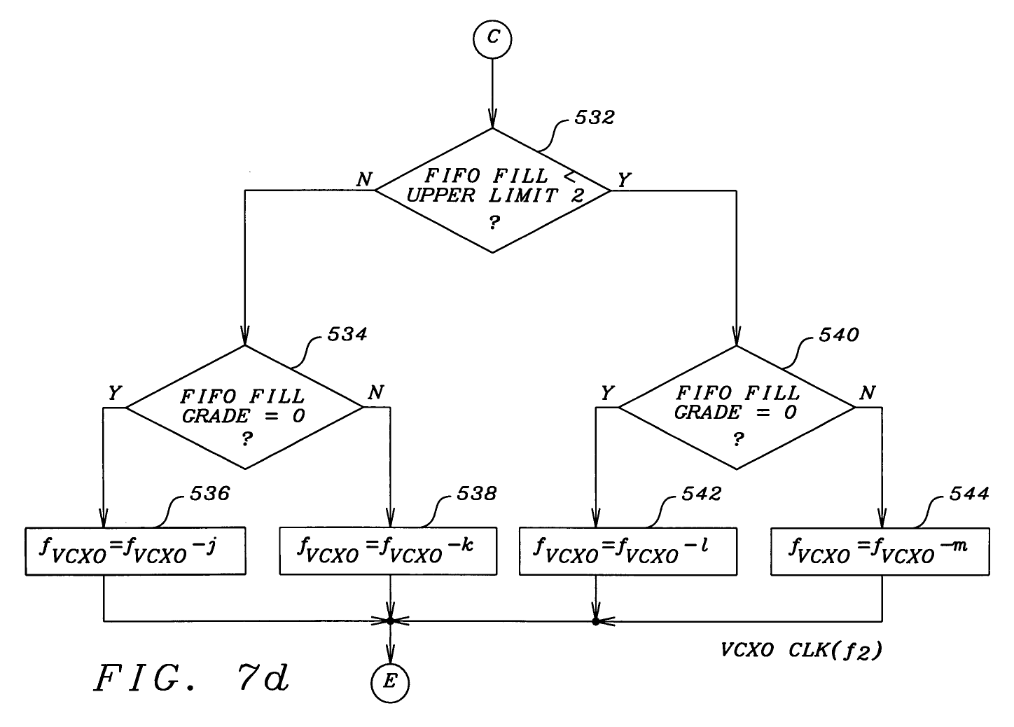

Refer now to FIGS. 7a-7d for a discussion of the method for the communication of digital data symbols of this invention. The steps for the method of communications for the digital data symbols are performed at essentially three different rates—the rate (fₜ) established by the transmitter clock 300, the rate (f₁) established by the receiver clock 400, and the rate (f₂) established by the jitter management clock 500. The steps for the transmitting of the digital data symbols of the method of communications begins by sampling an analog signal to acquire (Box 305) the digital data symbols. An error detection and correction code is generated (Box 310) and appended to the digital data symbols. The digital data symbols are then interleaved (Box 315) to allow the error and detection codes to be enhanced by preventing corruption of adjacent data within the digital data symbols. The interleaved digital data symbols with the attendant error detection and correction codes are serialized and formatted (Box 320) as described in FIG. 5. The serialized and formatted digital data symbols then modulate (Box 325) a transmission signal. In the preferred embodiment, the serialized and formatted digital data symbols are encoded using a four-pulse position modulation scheme, as described above. The modulated signal is transmitted (Box 330) to a transmission medium such as the atmosphere for conveyance to a receiver. The steps for transmitting the digital data symbols within the modulated signal (Boxes 305-330) are all synchronized by the frequency fₜ of the transmit clock 300.

The modulated signal is received (Box 405), amplified, conditioned, sampled, and decoded (Box 410) to recover the digital data symbols. The sampling of the modulated signal has a sampling rate that is a factor n times the frequency f₂ of the receiver clock 400. This sampling allows the determination of the transitions within the modulated signal, which are then decoded to recover the digital data symbols. The recovered digital data symbols are then placed (Box 425) within a buffer, which retains the digital data symbols for further processing. Simultaneously, the recovered digital data symbols are examined to detect (Box 415) the synchronization field and start pattern embedded within the framed of the recovered digital data symbols. Upon detection of the synchronization field and the start pattern, a frame marker is generated (Box 420) to demarcate the beginning of a frame of the digital data symbols.

The digital data symbols are extracted from the buffer and deinterleaved (Box 430) to recover the correct order of the digital data symbols. The deinterleaved digital data symbols then have an error detection and correction process applied (Box 435) to correct any errors that may have occurred during the transmission of the modulated signal.

A check for the occurrence of the frame marker signal is performed (Box 440). If there is a marker, a read address counter x is initiated (Box 445) to control the transfer of the frame of digital data symbols from the buffer to a FIFO buffer. The FIFO buffer is tested (Box 450) for the presence of any digital data symbols in the FIFO buffer. At the beginning of a transfer of the digital data symbols, there are no digital data symbols present in the FIFO buffer. The digital data symbols pointed to by the read address counter x are transferred (Box 455) from the buffer to the FIFO buffer. The FIFO buffer is then tested (Box 460) if the FIFO buffer has reached a threshold ( 1/2 full). If the threshold level has not been reached, the read address counter x is incremented (Box 465) to point to the next address and the next digital data symbol is transferred (Box 465) to the FIFO buffer. The FIFO buffer is then tested again (Box 460).

When the amount of the digital data symbols in the FIFO buffer have reached the threshold, the digital data symbols are then extracted from the FIFO. But simultaneously, the read address counter x is incremented (Box 480) to point to the next address and the next digital data symbol is transferred (Box 470) to the FIFO buffer. The read address counter is tested (Box 475) if the total number (n) of the digital data symbols of the frame is transferred to the FIFO buffer. If all the symbols have not been transferred, the read address counter x is incremented (Box 480) and the digital data symbols transferred (Box 470) from the buffer to the FIFO buffer until all the digital data symbols of the frame are transferred.

At the reception of the next frame marker, the read address counter x is initialized (Box 445) and, since the FIFO buffer is not now empty, the next frame of digital data symbols is transferred from the buffer to the FIFO buffer. Because the frequency fₜ of the transmit clock 300 is not exactly equal in period or phase to the frequency f₁ of the receive clock 400, all of the digital data symbols of the frame must be transferred from the buffer to the FIFO buffer in the period of time between two of the frame markers. In the preferred embodiment of this method, two of the digital data symbols are transferred from the buffer to the FIFO buffer essentially simultaneously. The number of digital data symbols to be transmitted simultaneously is determined by the frequency fₜ of the transmit clock 300 versus the frequency f₁ of the receive clock 400. Therefore, any number of digital data symbols maybe transferred simultaneously and still be in keeping with the intent of this invention.

When the test (Box 460) for the amount of digital data symbols present within the FIFO buffer indicates that the amount of digital data symbols present within the FIFO buffer is greater than the threshold, the read address counter y is initialized (Box 502) to point to the first digital data symbol of the frame being transferred to the FIFO buffer. The digital data symbols pointed to by the read address counter y is transferred (Box 504) from the FIFO buffer. In the preferred embodiment of this invention, the digital data symbols are transferred to a digital-to-analog converter for conversion to an audio analog signal that is applied to speakers.

The amount of digital data symbols present within the FIFO buffer is tested if it is greater than the Upper Limit 1 (UL1) (Box 506) or less than the Lower Limit 1 (LL1) (Box 508). If the amount of digital data symbols present within the FIFO buffer is neither greater than the Upper Limit 1 (UL1) (Box 506) nor less than the Lower Limit 1 (LL1) (Box 508), a gradient of the consumption of the digital data symbols from the FIFO buffer versus the supplying of the digital data symbols to the FIFO buffer is tested (Box 510). If the gradient indicates the net rate that the amount of digital data symbols present within the FIFO buffer are being consumed or supplied to the FIFO buffer. If the rate of consumption or the rate of supply is too great, the frequency f₂ of the jitter management clock 400 is increased or decreased incrementally (f₂+/−i) (Box 512) to decrease the gradient. On the other hand, if the gradient indicates that rate of consumption is within the boundaries of the Upper Limit 1 (UL1) (Box 506) or the Lower Limit 1 (LL1), the frequency f₂ of the jitter management clock 500 is held constant.

The read address y is incremented (Box 514) and the amount of digital data symbols present within the FIFO buffer is tested (Box 516) if the FIFO buffer is empty. If it is not empty, the set of next digital data symbols are transferred (Box 504) from the FIFO buffer. As long as the amount of digital data symbols present within the FIFO buffer are less than the Upper Limit 1 (UL1) (Box 506) or greater than the Lower Limit 1 (LL1) (Box 508), the read address counter y is incremented (Box 514) and the digital data symbols are transferred (Box 504) until no more digital data symbols are being transferred from the buffer to the FIFO buffer and the FIFO buffer is empty. When the FIFO buffer is empty, the method returns to start the process of receiving (Box 405) the modulated signal.

When the amount of digital data symbols present within the FIFO buffer is tested (Box 506) for being greater than the Upper Limit 1 (UL1) and if found to be greater than the upper limit, the jitter management clock 500 has a frequency f₂ less than the frequency fₜ of the transmit clock 300 and must be raised to increase the consumption rate of the digital data symbols from the FIFO buffer. The amount of digital data symbols present in the buffer is first tested (Box 518) greater than the Upper Limit 2 (UL2). If the amount of digital data symbols is not greater than the Upper Limit 2 (UL2), the gradient of the consumption of the digital data symbols from the FIFO buffer versus the supplying of the digital data symbols to the FIFO buffer is tested (Box 520). If the gradient indicates the rate of consumption or the rate of supply is not too great, the frequency f₂ of the jitter management clock 400 is increased incrementally (f₂+j) (Box 522) to increase the rate of consumption of the digital data symbols. If the gradient of the consumption indicates rate of supply is too great, the frequency f₂ of the jitter management clock 400 is increased by a larger increment (f₂+k) (Box 524) to decrease the gradient and increase the rate of consumption more rapidly.

However, If the amount of digital data symbols is greater than the Upper Limit 2 (UL2), the gradient of the consumption of the digital data symbols from the FIFO buffer versus the supplying of the digital data symbols to the FIFO buffer is again tested (Box 526). If the gradient indicates the rate of consumption or the rate of supply is not too great, the frequency f₂ of the jitter management clock 400 is increased by an even larger increment (f₂+l) (Box 528) to increase the rate of consumption of the digital data symbols more drastically the decrease the amount of digital data symbols within the FIFO buffer to prevent an overrun. If the gradient of the consumption indicates rate of supply is too great, the frequency f₂ of the jitter management clock 400 is increased still more dramatically (f₂+/−m) (Box 530) to decrease the gradient and increase the rate of consumption even more rapidly.

When the amount of digital data symbols present within the FIFO buffer is tested (Box 508) for being less than the Lower Limit 1 (LL1) and if found to be less than the lower limit, the jitter management clock 500 has a frequency f₂ greater than the frequency fₜ of the transmit clock 300 and must be lowered to decrease the consumption rate of the digital data symbols from the FIFO buffer. The amount of digital data symbols present in the buffer is first tested (Box 532) less than the Lower Limit 2 (LL2). If the amount of digital data symbols is not less than the Lower Limit 2 (LL2), the gradient of the consumption of the digital data symbols from the FIFO buffer versus the supplying of the digital data symbols to the FIFO buffer is tested (Box 534). If the gradient indicates the rate of consumption or the rate of supply is not too great, the frequency f₂ of the jitter management clock 400 is decreased incrementally (f₂−j) (Box 522) to decrease the rate of consumption of the digital data symbols. If the gradient of the consumption indicates rate of supply is too great, the frequency f₂ of the jitter management clock 400 is decreased by a larger increment (f₂−k) (Box 536) to decrease the gradient and decrease the rate of consumption more rapidly.

However, If the amount of digital data symbols is less than the Lower Limit 2 (LL2), the gradient of the consumption of the digital data symbols from the FIFO buffer versus the supplying of the digital data symbols to the FIFO buffer is again tested (Box 540). If the gradient indicates the rate of consumption or the rate of supply is not too great, the frequency f₂ of the jitter management clock 400 is decreased by an even larger increment (f₂−l) (Box 542) to decrease the rate of consumption of the digital data symbols more drastically the decrease the amount of digital data symbols within the FIFO buffer to prevent an overrun. If the gradient of the consumption indicates rate of supply is too great, the frequency f₂ of the jitter management clock 400 is decreased still more dramatically (f₂−m) (Box 544) to decrease the gradient and decrease the rate of consumption even more rapidly.

Refer back now to FIG. 7b. If a frame marker is tested (Box 440) and no frame marker is detected, the received data is corrupted and invalid. The buffer is cleared of the data and the data is flushed (Box 480) from the FIFO buffer to eliminate the corrupted data. In an application such as playback of audio signals, the digital data symbols must be streamed isochronously. To prevent distortion and undesirable tones, the digital data symbols must be set to values that null the audio signal. Once the FIFO is flushed (Box 180), the next start pattern is detected (Box 415) and the digital data symbols recovered from the modulated signal are placed (Box 425) in the buffer and the process of streaming the digital data symbols continues upon the detection (Box 415) of the start pattern.

The buffer and FIFO buffer as described maybe implemented as a random access memory with the control of the access being provided by a group of state machines. The group of state machines implements the circuit functions as described above. An arbitrator circuit resolves any simultaneous conflicts of access for writing and reading to the random access memory. For instance the simultaneous transfer of the two sets of data symbols within a frame are accomplished by two state machines operating independently but essentially simultaneously, with the arbitrator circuit determining which state machine writes the data to the FIFO buffer.

While this invention has been particularly shown and described with reference to the preferred embodiments thereof, it will be understood by those skilled in the art that various changes in form and details may be made without departing from the spirit and scope of the invention.

The invention claimed is:

1. A receiver for acquiring modulated signals, restoring said modulated signal, reconstructing symbols of digital data from said modulated signal and synchronizing said digital data to a first reference signal, said receiver comprising:
a jitter management unit to synchronize the digital data to the first reference signal, said jitter management unit comprising:
a FIFO data retention device which receives the reconstructed digital data and transmits the synchronized digital data for further processing;
a variable reference signal generator connected to the FIFO data retention device to provide said first reference signal for synchronization of said digital data; and
a generator control circuit connected to receive a marker signal extracted from said modulated signal and in communication with the FIFO data retention device to receive an occupation signal indicating an amount of digital data present within said FIFO data retention device and from said marker signal and said occupation signal creates a generator control signal to cause an adjustment of said reference signal such that said first reference signal is synchronizes said digital data to a timing at which said digital data is transmitted.

2. The receiver of claim 1 further comprising:
an amplification and conditioning circuit connected to receive, restore, and sample the modulated signal, said modulated signal being sampled at a multiple of a second reference signal such that transitions representing boundaries between bits of said digital data within said modulated signal are detected and said digital data is reconstructed and synchronized to said second reference signal.

3. The receiver of claim 2 further comprising:
a buffer data retention circuit in communication with said amplification and conditioning circuit to receive and retain said reconstructed digital data and in communication with said FIFO data retention device to transfer said digital data to said FIFO data retention device.

4. The receiver of claim 3 wherein said buffer data retention circuit has at least one buffer circuit, each buffer circuit retaining a grouping of said symbols of digital data.

5. The receiver of claim 3 further comprising:
a data correction and deinterleaving circuit in communication with said buffer retention circuit to receive the reconstructed digital data and to reorganize said digital data to an original sequence of symbols, to correct any error created in transmission of said modulated signal, and replace the reorganized and corrected digital data within said buffer retention circuit.

6. The receiver of claim 3 wherein the buffer data retention circuit transfers said digital data to said FIFO data retention device at a rate of the second reference signal.

7. The receiver of claim 3 wherein the buffer data retention circuit transfers said digital data to the FIFO data retention device until said FIFO data retention device contains a first amount, where upon said FIFO data retention device begins to transmit said digital data.

8. The receiver of claim 7 wherein said buffer data retention circuit transfers all symbols of the digital data present between two marker signals to prevent overrun of said digital data.

9. The receiver of claim 2 further comprising:
a boundary marker signal detection circuit in communication with the amplification and conditioning circuit to receive the reconstructed digital data, from said reconstructed digital data extracting the marker signal indicating a boundary of symbols of said digital data, and in communication with the generator control circuit to provide said marker signal to said generator control circuit.

10. The receiver of claim 1 wherein, if the occupation signal indicates that said FIFO data retention device contains a second amount of the digital data, the generator control signal indicates that the generator control circuit to cause no adjustment to the second reference signal.

11. The receiver of claim 1 wherein, if the occupation signal indicates that said FIFO data retention device contains less than the second amount of the digital data, the generator control signal indicates that the generator control circuit to cause adjustment to the second reference signal to increase the contents of said FIFO data retention device until it contains said second amount.

12. The receiver of claim 1 wherein, if the occupation signal indicates that said FIFO data retention device contains greater than the second amount of the digital data, the generator control signal indicates that the generator control circuit to cause adjustment to the second reference signal to decrease the contents of said FIFO data retention device until it contains said second amount.

13. A data communication system comprising:
a transmission apparatus including:
a frame formatter to encode digital data into series of symbols;
a transmitter in communication with the frame formatter to receive the series of symbols and transmit a modulates signal composed of the series of symbols; and
a receiving apparatus in communication with said transmission apparatus for acquiring the modulated signal, restoring said modulated signal, reconstructing said symbols of the digital data from said modulated signal and synchronizing said digital data to a first reference signal, said receiving apparatus comprising:
a jitter management unit to synchronize the digital data to the first reference signal, said jitter management unit comprising:
a FIFO data retention device which receives the reconstructed digital data and transmits the synchronized digital data for further processing,
a variable reference signal generator connected to the FIFO data retention device to provide said first reference signal for synchronization of said digital data, and
a generator control circuit connected to receive a marker signal extracted from said modulated signal and in communication with the FIFO data retention device to receive an occupation signal indicating an amount of digital data present within said FIFO data retention device and from said marker signal and said occupation signal creates a generator control signal to cause an adjustment of said reference signal such that said first reference signal is synchronizes said digital data to a timing at which said digital data is transmitted.

14. The data communication system of claim 13 wherein the receiving apparatus further comprises:
an amplification and conditioning circuit connected to receive, restore, and sample the modulated signal, said modulated signal being sampled at a multiple of a second reference signal such that transitions representing boundaries between bits of said digital data within said modulated signal are detected and said digital data is reconstructed and synchronized to said second reference signal.

15. The communication system of claim 14 wherein the receiving apparatus further comprises:
a buffer data retention circuit in communication with said amplification and conditioning circuit to receive and retain said reconstructed digital data and in communication with said FIFO data retention device to transfer said digital data to said FIFO data retention device.

16. The data communication system of claim 15 wherein said buffer data retention circuit has at least one buffer circuit, each buffer circuit retaining a grouping of said symbols of digital data.

17. The data communication system of claim 15 wherein the receiving apparatus further comprises:
a data correction and deinterleaving circuit in communication with said buffer retention circuit to receive the reconstructed digital data and to reorganize said digital data to an original sequence of symbols, to correct any error created in transmission of said modulated signal, and replace the reorganized and corrected digital data within said buffer retention circuit.

18. The data communication system of claim 15 wherein the buffer data retention circuit transfers said digital data to said FIFO data retention device at a rate of the second reference signal.

19. The data communication system of claim 15 wherein the buffer data retention circuit transfers said digital data to the FIFO data retention device until said FIFO data retention device contains a first amount, where upon said FIFO data retention device begins to transmit said digital data.

20. The data communication system of claim 19 wherein said buffer data retention circuit transfers all symbols of the digital data present between two marker signals to prevent overrun of said digital data.

21. The data communication system of claim 14 wherein the receiving apparatus further comprises:
a boundary marker signal detection circuit in communication with the amplification and conditioning circuit to receive the reconstructed digital data, from said reconstructed digital data extracting the marker signal indicating a boundary of symbols of said digital data, and in communication with the generator control circuit to provide said marker signal to said generator control circuit.

22. The data communication system of claim 13 wherein, if the occupation signal indicates that said FIFO data retention device contains a second amount of the digital data, the generator control signal indicates that the generator control circuit to cause no adjustment to the second reference signal.

23. The data communication system of claim 13 wherein, if the occupation signal indicates that said FIFO data retention device contains less than the second amount of the digital data, the generator control signal indicates that the generator control circuit to cause adjustment to the second reference signal to increase the contents of said FIFO data retention device until it contains said second amount.

24. The data communication system of claim 13 wherein, if the occupation signal indicates that said FIFO data retention device contains greater than the second amount of the digital data, the generator control signal indicates that the generator control circuit to cause adjustment to the second reference signal to decrease the contents of said FIFO data retention device until it contains said second amount.

25. A digital data synchronizing circuit for synchronizing for digital data clocked to a first reference period to be clocked to a second reference period, said receiver comprising:
a FIFO data retention device which receives the digital data clocked at the first reference period and transmits the synchronized digital data at the second reference period;
a variable reference signal generator connected to the FIFO data retention device to provide a clock having the second reference period for synchronization of said digital data; and
a generator control circuit connected to receive a marker signal indicative of a beginning of groupings of symbols of said digital data and in communication with the FIFO data retention device to receive an occupation signal indicating an amount of digital data present within said FIFO data retention device and from said marker signal and said occupation signal creates a generator control signal to cause an adjustment of said reference signal such that said clock signal having the second reference period synchronizes said digital data to the second reference period.

26. The digital data synchronizing circuit of claim 25 wherein said digital data is transferred to the FIFO data retention device until said FIFO data retention device contains a first amount, where upon said FIFO data retention device begins to transmit said digital data.

27. The digital data synchronizing circuit of claim 26 wherein all symbols of the digital data present between two marker signals are transferred to FIFO data retention device to prevent overrun of said digital data.

28. The digital data synchronizing circuit of claim 25 wherein, if the occupation signal indicates that said FIFO data retention device contains a second amount of the digital data, the generator control signal indicates that the generator control circuit to cause no adjustment to the second reference signal.

29. The digital data synchronizing circuit of claim 25 wherein, if the occupation signal indicates that said FIFO data retention device contains less than the second amount of the digital data, the generator control signal indicates that the generator control circuit to cause adjustment to the second reference signal to increase the contents of said FIFO data retention device until it contains said second amount.

30. The digital data synchronizing circuit 25 wherein, if the occupation signal indicates that said FIFO data retention device contains greater than the second amount of the digital data, the generator control signal indicates that the generator control circuit to cause adjustment to the second reference signal to decrease the contents of said FIFO data retention device until it contains said second amount.

31. A method for synchronizing digital data timed by a clock having a first period transferred to circuitry having a clock with a second period, comprising the steps of:
providing a FIFO data retention device;
transferring said digital data into said FIFO data retention device with the clock with the first period;
transferring said digital data from said FIFO data retention device with the clock with the second period;
monitoring an occupation signal from said FIFO data retention device indicating an amount of digital data present within said FIFO data retention device;
monitoring a marker signal indicating a boundary between groupings of said digital data; and
dependent-upon occupation signal and said marker signal, adjusting said clock of said second period to synchronize said digital data to said second clock period.

32. The method of claim 31 wherein transferring said digital data to the FIFO data retention device occurs until said FIFO data retention device contains a first amount, where upon transferring said digital data from said FIFO data retention device begins.

33. The method of claim 31 wherein all symbols of the digital data present between two marker signals are transferred in a period of time between said two markers to FIFO data retention device to prevent overrun of said digital data.

34. The method of claim 31 wherein, if the occupation signal indicates that said FIFO data retention device contains a second amount of the digital data, not adjusting of the clock with the second period.

35. The method of claim 31 wherein, if the occupation signal indicates that said FIFO data retention device contains less than the second amount of the digital data, adjusting of the clock with the second period to cause the clock with the second period to increase the contents of said FIFO data retention device until it contains said second amount.

36. The digital data synchronizing circuit 31 wherein, if the occupation signal indicates that said FIFO data retention device contains greater than the second amount of the digital data, adjusting of the clock of the second period to cause adjustment to the clock with the second period to decrease the contents of said FIFO data retention device until it contains said second amount.

37. A method for receiving digital data transmitted with at a first clock rate comprising the steps of:
acquiring and restoring modulated signals, said modulated signals being modulated by said digital data;
reconstructing and synchronizing symbols of digital data from said modulated signal with a clock having a first period;
transferring said to circuitry having a clock with a second period by the steps of:
providing a FIFO data retention device;
transferring said digital data into said FIFO data retention device with the clock with the first period;
transferring said digital data from said FIFO data retention device with the clock with the second period;
monitoring an occupation signal from said FIFO data retention device indicating an amount of digital data present within said FIFO data retention device;
monitoring a marker signal indicating a boundary between groupings of said digital data; and
dependent upon occupation signal and said marker signal, adjusting said clock of said second period to synchronize said digital data to said second clock period.

38. The method of claim 37 further comprising the step of extracting the marker signal from said modulated signal.

39. The method of claim 37 further comprising the step correcting errors occurring during transmission of said modulated signal.

40. The method of claim 37 further comprising the step of deinterleaving said digital data to reorganize said digital data to an original sequence of symbols.

41. The method of claim 37 wherein transferring said digital data to the FIFO data retention device occurs until said FIFO data retention device contains a first amount, where upon transferring said digital data from said FIFO data retention device begins.

42. The method of claim 37 wherein all symbols of the digital data present between two marker signals are transferred in a period of time between said two markers to FIFO data retention device to prevent overrun of said digital data.

43. The method of claim 37 wherein, if the occupation signal indicates that said FIFO data retention device contains a second amount of the digital data, not adjusting of the clock with the second period.

44. The method of claim 37 wherein, if the occupation signal indicates that said FIFO data retention device contains less than the second amount of the digital data, adjusting of the clock with the second period to cause the clock with the second period to increase the contents of said FIFO data retention device until it contains said second amount.

45. The method of claim 37 wherein, if the occupation signal indicates that said FIFO data retention device contains more than the second amount of the digital data, adjusting of the clock with the second period to cause the clock with the second period to decrease the contents of said FIFO data retention device until it contains said second amount.

46. A method for communicating digital data from a first location to a second location, comprising the steps of:
transmitting a modulated signal modulated by said digital data, said digital data being synchronized with a first clock rate; and
receiving said digital data by the steps of:
acquiring and restoring modulated signals, said,
reconstructing and synchronizing symbols of digital data from said modulated signal with a clock having a first period,
transferring said to circuitry having a clock with a second period by the steps of:
providing a FIFO data retention device,
transferring said digital data into said FIFO data retention device with the clock with the first period,
transferring said digital data from said FIFO data retention device with the clock with the second period,
monitoring an occupation signal from said FIFO data retention device indicating an amount of digital data present within said FIFO data retention device,
monitoring a marker signal indicating a boundary between groupings of said digital data, and
dependent upon occupation signal and said marker signal, adjusting said clock of said second period to synchronize said digital data to said second clock period.

47. The method of claim 46 wherein receiving said digital data further comprises the step of extracting the marker signal from said modulated signal,

48. The method of claim 46 wherein transferred said digital data to the FIFO data retention device occurs until said FIFO data retention device contains a first amount, where upon transferring said digital data from said FIFO data retention device begins.

49. The method of claim 46 wherein all symbols of the digital data present between two marker signals are transferred in a period of time between said two markers to FIFO data retention device to prevent overrun of said digital data.

50. The method of claim 46 wherein, if the occupation signal indicates that said FIFO data retention device contains a second amount of the digital data, not adjusting of the clock with the second period.

51. The method of claim 46 wherein, if the occupation signal indicates that said FIFO data retention device contains less than the second amount of the digital data, adjusting of the clock with the second period to cause the clock with the second period to increase the contents of said FIFO data retention device until it contains said second amount.
